(19) United States
(12) Patent Application Publication
(10) Pub. No.: US 2009/0006795 A1
(43) Pub. Date: Jan. 1, 2009

(54) Security protection for cumputer long-term memory devices

(76) Inventors: Steven Bress, Germantown, MD (US); Mark Joseph Menz, Folsom, CA (US)

Correspondence Address: Steven Bress, 7851-C Beechcraft Avenue, Gaithersburg, MD, 20879, US

(21) Appl. No.: 11/465,934

(22) Filed: Aug. 21, 2006

Related U.S. Application Data
(60) Provisional application No. 60/595,972, filed on Aug. 22, 2005.

(51) Int. Cl. G06F 12/00; G06F 9/455; G06F 12/14

(52) U.S. Cl. 711/163; 703/25; 711/E12.001; 711/E12.091

(57) ABSTRACT

A security protection device provides protection for computer long-term storage devices, such as hard drives. The security protection device is placed between a host computer and the storage device. The security protection device intercepts communications between the host and the storage device and examines any commands from the host to the storage device. Only “safe” commands that match commands on a pre-approved list are passed to the storage device. All other commands may be discarded.

### RELATED APPLICATION

This application claims priority under 35 U.S.C. § 119 based on U.S. Provisional Application No. 60/595,972, filed Aug. 22, 2005, the disclosure of which is incorporated herein by reference.

### CROSS-REFERENCE TO RELATED APPLICATION

This application is related to application Ser. No. 96147, filed Sep. 25, 2001, now U.S. Pat. No. 6,813,682 granted Nov. 2, 2004.

### BACKGROUND OF THE INVENTION

A. Field of the Invention

The present invention relates to computer memory devices, and, more specifically, to mechanisms for protecting memory device controllers from accepting and/or issuing undesired commands.

B. Description of Related Art

There is an ongoing need to protect computer memory devices from attacks. As attackers become more sophisticated, they are able to bypass operating systems and attempt to attack computer memory devices directly. These attacks can be classified in three broad categories: 1. using known a known command, such as “format”; 2. using an unknown/unpublished command; 3. using a sequence of innocent-appearing commands to activate an “easter egg”.

For the sake of clarity the following description will be described with reference to an IDE magnetic hard drive, although, the concepts of the invention are not limited to such drives. One skilled in the art would appreciate that other modern long-term storage device interfaces share similar functionality that could be incorporated into the concepts described herein.

1. Known Commands. Known commands include, but are not limited to commands such as “format” and “change password”. The command set for the industry standard IDE hard drives includes a command that can force the drive to format itself. (www.t13.org) Should this command be issued, all data on the drive would be irretrievably lost within a very short period of time. There would be no external indication that the command was being executed.

The command set for IDE hard drives contains commands to change the password on a drive. Once a password is set, the drive may be locked and thus the data would be unavailable to all users without the changed password. If an individual has physical control of a computer, changing passwords and locking a drive may take just seconds. A password changing attack may be of particular interest to some malicious individuals, as the data is still on the computer, and in-effect, the drive may be held hostage.

2. Unknown Commands. “Technical Committee T13 is responsible for all interface standards relating to the popular AT Attachment (ATA) storage interface utilized as the disk drive interface on most personal and mobile computers today.” http://www.t13.org/T13 publishes a list of approved drive commands (known). However, there is nothing to prevent a drive manufacturer from adding additional commands and not revealing them (hidden). A manufacturer may add a command that bypasses a need for a password, for example. If this command was subsequently found and got into malicious hands it could be used to launch an attack on computer memory devices from that manufacturer.

3. Easter Eggs. Easter Eggs are seemingly innocent sequences that unlock hidden code. For example, in the Xbox game Fantastic 4, to unlock the “Hell Bonus Level,” a player: quickly presses Right, Right, X, B, Left, Up, Down at the Main Menu. If a sequence is long enough, it is unlikely to be accidentally stumbled upon, but is easy to trigger if you know the entire sequence. An easter egg on a computer memory device could be triggered by a seemingly random and innocent set of commands such as: “read sector 100, read sector 100,000, write sector 100, read sector 567,879,000, then get the Drive information.

An easter egg may trigger any sort of code, innocent or malicious. It could just as easily be configured to display some advertising to a consumer, as it could be to format the drive so a consumer would lose all his data. As computer hard drives are manufactured in all corners of the world and are manufactured without any oversight authority, there is nothing to prevent a manufacturer from manufacturing computer memory devices with easter eggs on them.

Hardware Firewalls. There are a number of known conventional techniques for protecting long-term memory device controllers from malicious attacks. One class of techniques revolves around hardware firewalls. From Wikipedia: “In computing, a firewall is a piece of hardware and/or software which functions in a networked environment to prevent some communications forbidden by the security policy, analogous to the function of firewalls in building construction.

A firewall has the basic task of controlling traffic between different zones of trust. Typical zones of trust include the internet (a zone with no trust) and an internal network (a zone with high trust). The ultimate goal is to provide controlled connectivity between zones of differing trust levels through the enforcement of a security policy and connectivity model based on the least privilege principle.

Proper configuration of firewalls demands skill from the administrator. It requires considerable understanding of network protocols and of computer security. Small mistakes can render a firewall worthless as a security tool.” http://en.wikipedia.org/wiki/Firewall_%28networking%29

Software Protection. A second class of computer long-term memory device controller protection is based on software protection of the drive. In general, these techniques involve properly installing, updating and operating the software. If any of these steps are done incorrectly the software will be worthless as a security tool. Software security protection can be disabled by someone with physical access to a computer, such as a disgruntled employee. Additionally, this software may interfere with or slow normal operations of a computer.

Summary. If properly configured and maintained, current classes of protection may provide some protection from attacks using known commands as a basis for attack. They offer less protection from attacks using unknown commands and no protection from attacks using easter eggs. Additionally, current classes of protection offer no protection from a user with physical access to a computer.

Accordingly, there is a need in the art for an improved mechanism for security protection for computer long-term memory device controllers, such as a disk drive.

### SUMMARY OF THE INVENTION

Systems and methods consistent with the present invention address these and other needs by providing for an operating system independent security protection device that is physically inserted between a host computer and a storage device.

More particularly, the present invention intercepts commands from a host computer to a storage device. If a command is on a pre-determined approved list, the command is passed to the storage device with no action taken. If the command is not on a list, it is not passed to the storage device. The critical observations are that since only approved commands are passed, any unknown commands and/or new commands will be blocked, and normal operation of the host is unaffected.

The write blocking device of U.S. Pat. No. 6,813,682 is physically inserted between a host computer and a storage device. A processor when used as a blocking device is directed at blocking any changes to the data on a storage device, a processor when used as a security protection device is directed at blocking only those commands which are not required for day-to-day operations and may indicate a hostile attack, such as a format or change password command. Although a blocking device and a security protection device may appear superficially similar, in function they are not.

In operation, a processor examines commands generated by a host and intended for a storage device, the processor allowing only those of the commands that match a predetermined set of commands to pass to the storage device, the predetermined set of commands being commands that that are known to not pose a security risk.

To keep the operating system running smoothly some commands require a response to the operating system, such as setting a password. In this case, the processor is directed to accept the command and report a successful completion to the operating system, then discard the data without ever sending it to the storage device. The processor may also be directed to return status codes to the host computer indicating that the command completed successfully, even though it has effectively been blocked.

Another embodiment of the present invention provides protection against Easter egg attacks. In this case the processor is directed to perform one or more of the following steps: block read or write commands to addresses out of range; substitute a read or write command for a functionally similar read or write command; issue null commands to the storage device.

Keeping a log of blocked commands may prove to be useful. The processor may be directed to write to the standard communication port whenever a command is blocked. Frequent blocked commands may indicate an ongoing attack; in this case the processor may be directed to writing a specific code to the standard communication port, indicating an ongoing attack. Additionally the processor may be directed to block all commands in this instance.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram illustrating the logic flow of a security protection device.

FIG. 2. is a diagram illustrating the logic flow of a security protection device implementing more complex protection rules.

### DETAILED DESCRIPTION

The following detailed description of the invention refers to the accompanying drawings. The same reference numbers in different drawings identify the same or similar elements. Also, the following description does not limit the invention. Instead, the scope of the invention is defined by the appended claims and equivalents.

A security protection device is described herein that blocks commands that are not on a pre-approved list, as they are transmitted to a storage device. The security protection device is physically inserted between a host computer system and the storage device and is transparent to the host and the storage device. The hardware to build a security protection device is taught in U.S. Pat. No. 6,813,682.

The storage device may be any type of long-term non-volatile memory device. For example, the storage device may be a hard disk drive or compact flash memory. In one implementation, the storage device uses an Integrated Drive Electronics (IDE) interface. An IDE interface is a well-known electronic interface that is frequently used to connect a computer's motherboard and disk drive. In IDE drives, the disk drive controller is built into the physical case of the disk drive. The IDE interface provides a relatively high level interface between the motherboard and the disk drive.

Although concepts consistent with the present invention are primarily described herein in relation to an IDE magnetic hard disk drive, these concepts may be implemented with other types of IDE media, such as flash memory with an IDE interface. Flash memories are a special type of semiconductor random access memory that retains its data after power has been removed from the system. Other types of media useable with an IDE interface include magnetic tape and optical media, such as a compact disc (CD) and a digital versatile disc (DVD). In addition to the IDE interface, concepts consistent with the invention may be applied in a straightforward manner to other types of high level storage interfaces, such as the well known Small Computer System Interface (SCSI) standard or a hard drive connected through an IEEE 1394 (Firewire) connection.

For the sake of clarity the remaining description herein will be described with reference to an IDE magnetic hard drive, although, as mentioned above, the concepts of the invention are not limited to such drives. One skilled in the art would appreciate that other modern long-term storage device interfaces share similar functionality that could be incorporated into the concepts described herein.

Security Protection vs. Write Protection

Applicants' U.S. Pat. No. 6,813,682 teaches a write protection device. The goal of this write protection device is to secure all data on a storage device from a change in state. In order to accomplish this goal the normal function of the storage device is sacrificed. That is, the storage device is essentially read only and thus useless for ongoing normal functions.

The present invention teaches a security protection device. The goal of this security protection device is to protect a storage device, as much as possible, while maintaining the storage device's normal functionality. Thusly a write blocking device may block all write commands to a storage device, the security protection device may block only those commands considered not safe, such as format, or change password. Although similar in nature, the goals and operations of these two devices are very different.

Scope of Present Invention

The present invention uses the hardware taught in U.S. Pat. No. 6,813,682. This hardware is not in the scope of the present invention, and thus mentioned only in reference. The present invention is solely concerned with processes and logic performed by the processor of U.S. Pat. No. 6,813,682.

Security Protection Device

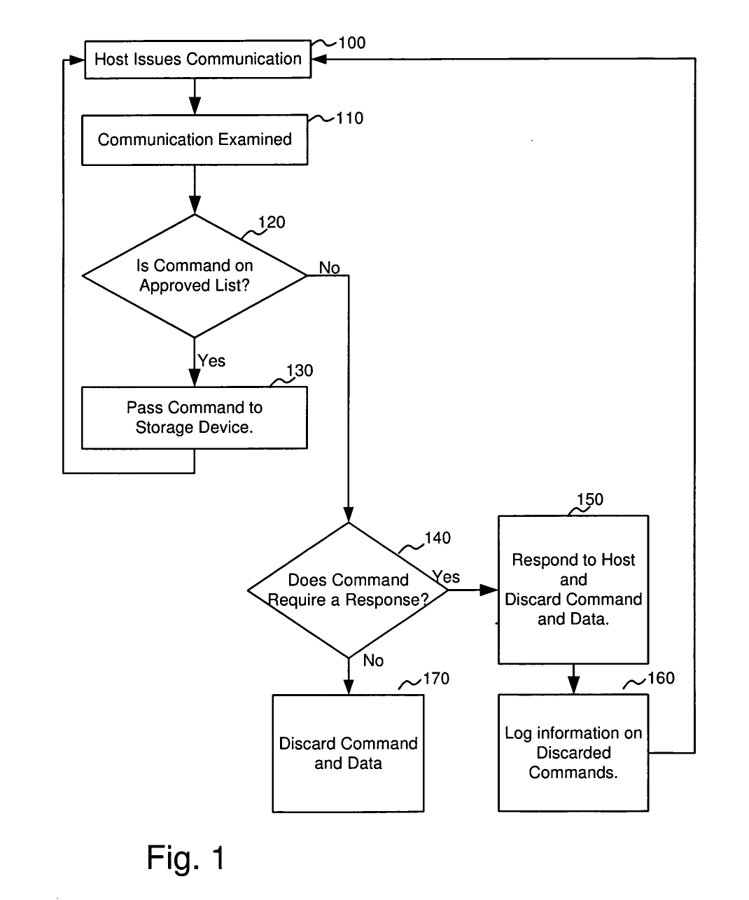

FIG. 1. is a flow chart illustrating the operation of security protection device. To begin, the host communicates a command to the storage device (act 100). The security protection device captures and holds communications until they are examined (act 110). The communication is examined for whether it matches a command on a pre-determined approved list. If yes, the command is passed to the storage device (act 130). If no, the command is examined for whether a response to the host is required (act 140). If yes, security protection device makes an appropriate response to the host, then discards the command and data (act 150). If no, the command and any associated data is discarded (act 170). Information on discarded commands is logged, such as writing it to the standard communication port (act 160). Because the security protection device accepts commands and any data associated with the command, the host believes the command and associated data has been successfully sent to the storage device.

A special case is if the host issues a drive capabilities request. The security protection device may modify a drive's capabilities. In this situation, the reported capabilities will be modified to reflect the actual capability of the storage device with the attached security protection device. This is taught in U.S. Pat. No. 6,813,682 and is outside of our present invention.

An Improved Security Protection Device

Generally speaking, the price of higher security is more system resources dedicated to security. That is, improved security may involve a trade off on the speed of a computer's normal functioning. With that in mind it is advantageous to have security devices that provide different levels of security.

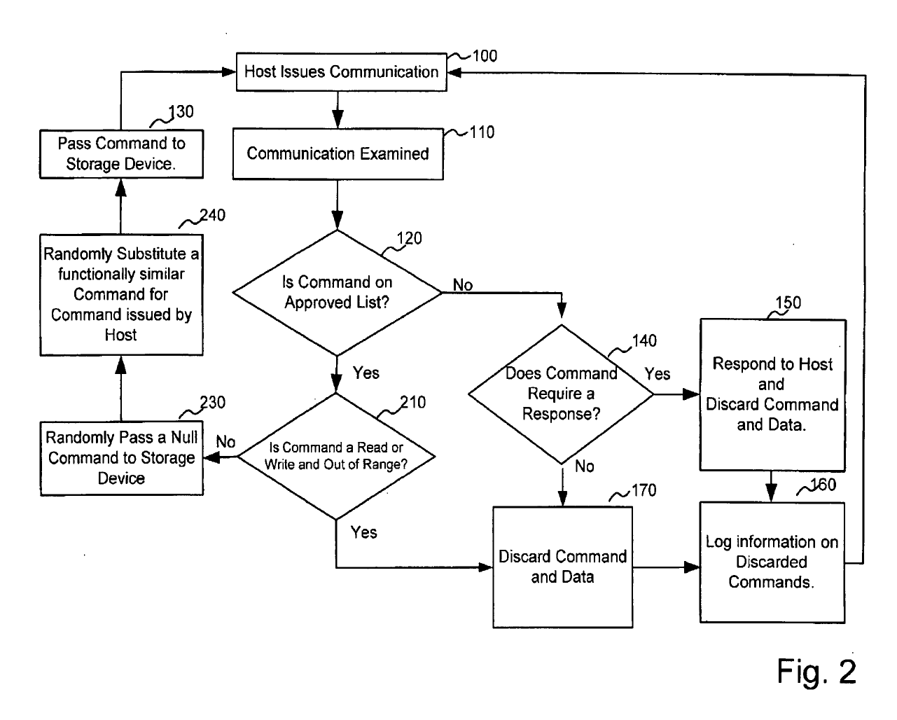

FIG. 2 is a flow chart illustrating the operation of an improved security protection device. The improved security protection device is an addition to the device described in FIG. 1. Acts 210, 230 and 240 are new. If a command is determined to be on the approved list, it is then examined for whether it is out of range (Act 210). That is, if it specifies a read or write to a location not supported by the storage device. If yes, the command and associated data is discarded (act 170). If no, a null command, such as a seek command may be sent to the storage device (act 240). The method for determining if a null command is sent to the storage device is unimportant, as long as it cannot be predicted.

As of this writing, there are three functionally similar, but syntactically different commands for reading data, and in some newer drives, five distinct read commands. The same is true for write commands. Our present invention can query the storage device and determine the appropriate set of read and write commands for a particular device. At random intervals, a functionally similar, but syntactically different command is substituted for the command sent from the host (act 240).

Ongoing Attack Security Protection

Frequent blocked commands of a certain type, such as format drive or change password may indicate an ongoing attack. In the case of an ongoing attack it would be prudent to notify an operator. To this end our present device could write a specific code to the standard communication port to indicate to a user that an ongoing attack is in progress. In addition, our present device upon determining there is an ongoing attack, could block all commands from a host for a pre-specified length of time.

### SUMMARY

As described above, a security protection device is inserted between a host computer and a storage device. The security protection device blocks commands that are not on a pre-approved safe command list from being sent to the storage device. Different levels of security protection are possible.

It will be apparent to one of ordinary skill in the art that the embodiments as described above may in implemented in many different forms of software, firmware and hardware. The actual software code or specialized control hardware used to implement aspects consistent with the present invention is not limiting of the present invention. Thus, the operation and behavior of the embodiments were described without specific reference to the specific software code, it being understood that a person of ordinary skill in the art would be able to design software and control hardware to implement the embodiments based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

No element, act or instruction used in the description of the present application should be construed as critical or essential to the invention unless explicitly described as such. Also, as used herein, the article “a” is intended to include one or more items. Where only one item is intended, the term “one” or similar language is used.

What is claimed is:

1. A security protection device comprising:
an interface emulator configured to emulate an interface presented by a storage device and configured to connect to a host;
an interface for connecting to the storage device; and
a processor coupled to the interface emulator and the interface, the processor examining commands received through the interface emulator that are generated by the host and intended for the storage device, the processor allowing only those of the commands that match a predetermined set of commands to pass to the storage device via the interface, the predetermined set of commands being commands that that are known to not pose a security risk,
wherein the security protection device is transparent to normal operation of the host and the storage device.

2. The security protection device of claim 1, wherein the interface is an integrated device electronics (IDE) interface for a disk drive.

3. The security protection device of claim 1, wherein the processor drops those of the commands that do not match the predetermined set of commands, and, after dropping one of the commands, returns status information to the host that indicates that the dropped command was successfully completed.

4. The security protection device of claim 1, wherein the processor drops those of the commands that address addresses out of range, and, after dropping one of the commands, returns status information to the host that indicates that the dropped command was successfully completed.

5. The security protection device of claim 1, wherein the processor substitutes a command from the host for a functionally similar command with a different syntax.

6. The security protection device of claim 1, wherein the processor inserts null commands between commands issued by the host.

7. The security protection device of claim 6, wherein the frequency of null commands inserted is determined by a user.

8. The security protection device of claim 1, wherein the processor maintains a log of blocked commands.

9. The security protection device of claim 8, wherein the processor writes a log of blocked commands to a standard communications port.

10. The security protection device of claim 8, wherein the processor examines a log of blocked commands for patterns that may indicate an ongoing attack.

11. The security protection device of claim 8, wherein the processor writes a specific code to the standard communication port when an ongoing attack pattern is recognized.

12. The security protection device of claim 8, wherein the processor blocks all commands from the host when an ongoing attack pattern is recognized.

13. The security protection device of claim 8, wherein the processor blocks all commands from the host that would change the status of the storage device when an ongoing attack pattern is recognized.

14. The security protection device of claim 1, further comprising: additional interfaces for connecting to additional storage devices.

15. The security protection device of claim 14, wherein each of the interfaces is independently coupled to the processor.

16. The security protection device of claim 1, further including light emitting diodes (LEDs) coupled to the processor and configured to transmit status information relating to the status of the security protection device.

17. A device comprising:
an IDE emulator component, the IDE emulator component including a physical interface designed to engage a first cable that connects to a host that controls an IDE storage device;
an IDE interface configured to engage a second cable that connects to the IDE storage device;
and a logic circuit connecting the IDE emulator component to the IDE interface and configured to: compare commands received at the IDE emulator component to a predetermined set of commands that are known to not to not pose a security risk, and to allow transmission of the commands from the IDE emulator component to the IDE interface when the comparison indicates that the received command is in the predetermined set of commands,
wherein the device operates transparently to normal operation of the host and the IDE storage device.

18. The device of claim 17, wherein the logic circuit drops those of the commands that address addresses out of range, and, after dropping one of the commands, returns status information to the host that indicates that the dropped command was successfully completed.

19. The device of claim 17, wherein the logic circuit substitutes a command from the host for a functionally similar command with a different syntax.

20. The device of claim 17, wherein the logic circuit inserts null commands between commands issued by the host.
